(19) United States
(12) Patent Application Publication
(10) Pub. No.: US 2006/0112410 A1
(43) Pub. Date: May 25, 2006

(54) Method and apparatus for presenting on-demand event records

(76) Inventors: Christopher Poli, Doylestown, PA (US); Richard S. Grzeczkowski, Warrington, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 10/996,155

(22) Filed: Nov. 23, 2004

(51) Int. Cl. H04N 7/173

(52) U.S. Cl. 725/86

(57) ABSTRACT

The present invention is a method and system for presenting on-demand event records in such a manner as to allow the user to easily identify which on-demand event records have been viewed already. Once a user views particular on-demand content, the present invention flags the particular on-demand content as pre-viewed by incrementing a flag indicator field in the on-demand event record corresponding to the particular on-demand content. Then, the next time the user interface communicating the available on-demand content is presented, the one or more user interface items presenting previously viewed on-demand content are presented with a previously viewed identifier. The previously viewed identifier may include, but is not limited to, presenting the previously viewed on-demand content in a different color than the unviewed on-demand content, presenting the previously viewed on-demand content in a different location than the unviewed on-demand content, or presenting only the unviewed on-demand content.

### FIELD OF THE INVENTION

The present invention relates to the field of communications networks, and more particularly, to a method and apparatus for presenting on-demand event records to a user in a communications network.

### BACKGROUND OF THE INVENTION

On-demand services, which are provided by many service providers, deliver stored digital files (streams) to many interactive users upon request. These on-demand services may include, but are not limited to, video-on-demand (VOD) services or audio-on-demand services. As these on-demand services continue to increase in popularity, more on-demand content will inevitably become available to communications network users via service providers.

To determine which on-demand content is available from their service provider, users typically maneuver through an on-demand user interface by scrolling down one or more lists comprising one or more user interface items displayed on a television device coupled to their set-top device. The display device presenting the on-demand user interface is communicatively coupled to the set-top device, which receives the on-demand content from a communications network such as a satellite television network. If the user decides to view particular on-demand content, the user enters a selection indication in response to the user interface item representing the particular on-demand content.

This prior art on-demand user interface typically groups the available on-demand content together by similar programming, such as episodes 1-23 of “SEINFELD” being grouped together, with each episode listed in chronological order with respect to the episode number. For example, the third episode of Seinfeld would be listed as “SEINFELD 3” and would be the third user interface item in the list of available on-demand content in the “SEINFELD” grouping presented on the on-demand user interface.

However, one of the problems with this prior art on-demand user interface is that the user may have difficulty determining which on-demand content the user has previously viewed. Typically, users may not remember the name of every episode they have watched, especially if the episode name presented in the on-demand event record is simply the name of the content followed by the episode number (such as, “SEINFELD 7”). Without knowing exactly which episodes the user has watched before, the user is at a risk of ordering on-demand content that has already been viewed by the particular user. Nothing is more frustrating for a user than to order, and pay for, on-demand content which they have already seen, when the user was hoping to view an unviewed episode.

Information regarding previously viewed on-demand content could prove very useful, not only in helping to prevent the on-demand event records in a manner which indicates which on-demand content has been viewed before, but in further supporting the relationship between the service provider and the user. For example, the service provider may wish to provide promotions for their on-demand content that would require this information, such as a “buy two, get one free” promotion for on-demand content. Information regarding which on-demand content has been previously viewed could assist service providers in supporting such promotions if such information were available to the service provider's business system.

Therefore, there is a need in the art for a method and apparatus for presenting available on-demand content in such a manner that the user may determine, at a glance, which user interface items represent previously viewed on-demand content. There is also a need in the art for a method and apparatus for managing such information regarding previously viewed on-demand content in such a manner that will further support the relationship between the service provider and the user.

### SUMMARY OF THE INVENTION

The present invention overcomes the aforementioned and other deficiencies in the prior art by providing a method and system for presenting available on-demand content via a user interface wherein the user may determine which user interface item represents previously viewed on-demand content. An on-demand event data structure comprises one or more on-demand event records corresponding to available on-demand content. Once a user views particular on-demand content, the on-demand event record corresponding to the on-demand content is flagged as “previewed” in an on-demand content data structure. Then, the next time the user interface is presented, the user interface items representing pre-viewed on demand content are presented in such a manner as to communicate to the user that the on-demand content has been previously viewed.

The present invention comprises both an on-demand server-based embodiment and a set-top device based embodiment. In the on-demand server based embodiment of the present invention, this on-demand content data structure is stored in a memory located in the on-demand server. In the set-top device based embodiment of the present invention, this on-demand content data structure is stored in a memory located in the set-top device.

### BRIEF DESCRIPTION OF THE DRAWINGS

For a fuller understanding of the present invention, reference is made to the following description taken in connection with the accompanying drawings, in which:

FIG. 1 is a simplified block diagram illustrating an exemplary system in accordance with the present invention.

FIG. 2 is a flow diagram illustrating an exemplary method in accordance with an embodiment of the present invention from the perspective of the set-top device in the set-top device embodiment.

FIG. 3 is a simplified block diagram illustrating an exemplary data structure for the on-demand event data structure in accordance with the present invention.

### DETAILED DESCRIPTION OF THE INVENTION

Generally, the present invention is a method and apparatus for presenting on-demand content. More particularly, the present invention is a method and apparatus for presenting on-demand event records in a manner in which the user can easily determine which on-demand content the user has previously viewed.

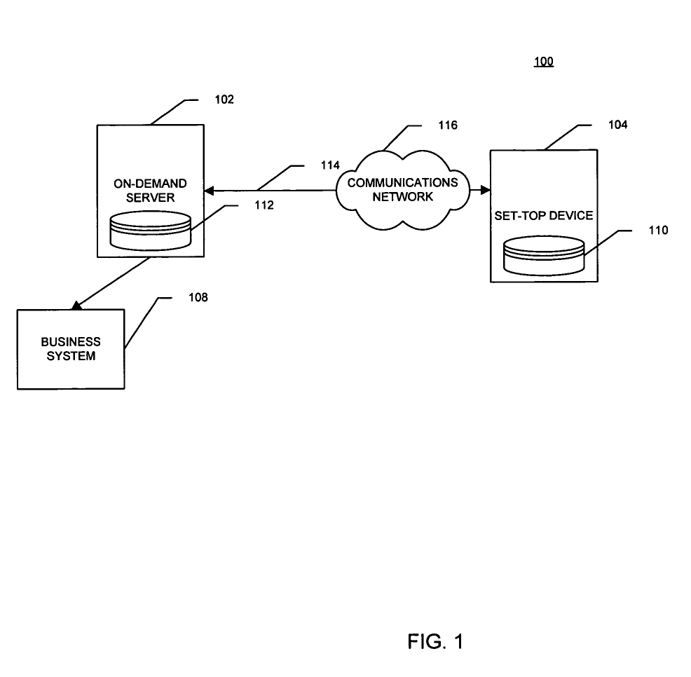

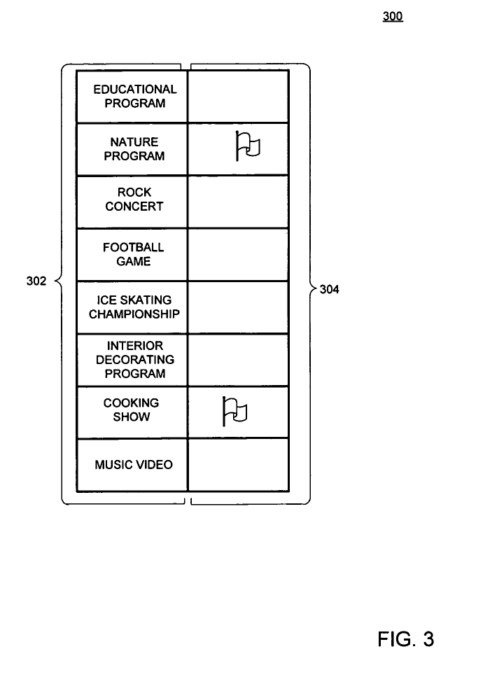

FIG. 1 is a simplified block diagram illustrating an exemplary system in accordance with the present invention. System 100 comprises on-demand server 102. An on-demand memory 112 is located within on-demand server 102, which may be utilized for storing a server based application in the server-based embodiment of the present invention. Furthermore, this on-demand memory may comprise the on-demand event data structure as later depicted in FIG. 3. On-demand server 102 is communicatively coupled to business system 108 and server based database 106 in the headend 118, and set-top device 104.

Set-top device 104 is a typical set-top device in the exemplary embodiment, but may comprise any electronic device capable of receiving on-demand content. Set-top device 104 comprises set-top memory 110, which may comprise either volatile or non-volatile memory. In the set-top device embodiment of the present invention, this set-top memory 110 is utilized to store a client application for operating in accordance with the method of the present invention, along with the on-demand event data structure later discussed in FIG. 3.

Content distribution channel 114 is located within video delivery network 116, and serves as a communication channel for on-demand content between the on-demand server 102 and the set-top device 104. Communications network 116 may comprise any network capable of communicating content from on-demand server 102 to the set-top device 104, including but not limited to, an (HFC) network, fiber network, Ethernet network, or an internet protocol (IP) network.

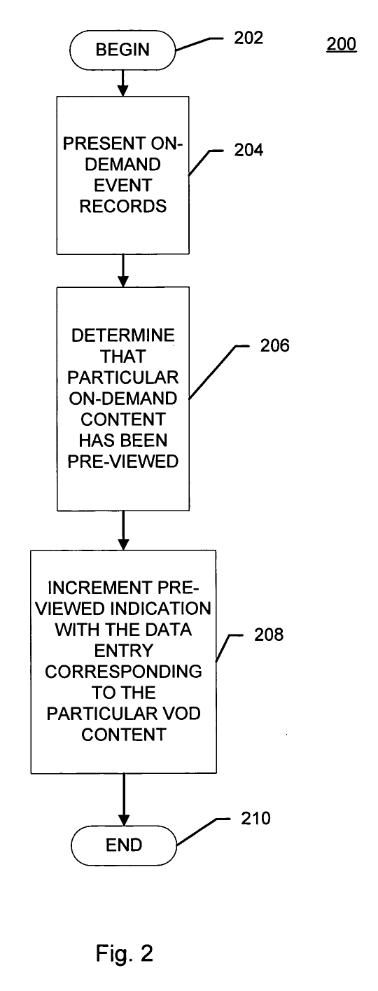

FIG. 2 is a flow diagram illustrating an exemplary method in accordance with an embodiment of the present invention from the perspective of the set-top device in the set-top device embodiment. Method 200 begins at step 202 and proceeds to the presentation of particular on-demand content at step 204. This step 202 comprises presenting the on-demand user interface comprising one or more user interface items, with each user interface item representing a particular on-demand event record in the on-demand event data structure, which is discussed in FIG. 3.

At step 206, the present invention determines that particular on-demand content has been previously viewed at step 206. This determination comprises the set-top device 104 determining that either the entirety of the particular on-demand content has been previously viewed, or that the particular content has been viewed past a particular threshold point. This threshold point may be pre-programmed into the set-top device 104 at the time of manufacture, or may be programmed into the set-top device 104 by the user. Furthermore, this determination may be made in response to receiving billing information from business system 108 indicating the user has purchased the particular on-demand content. In addition, this determination may be in response to an input from the user or set-top device 110 indicating that the particular content has been previously viewed.

At step 208, the set-top device increments the previously viewed indication with the on-demand event record corresponding to the particular on-demand content in the on-demand event data structure. Once the on-demand event record has been incremented, the on-demand user interface may present the user interface item representing the on-demand event record with a previously viewed identifier which indicates that the on-demand content corresponding to the on-demand event record has been previously viewed. This previously viewed identifier may include, but is not limited to, presenting the user interface item in a different location, or a different color, than user interface items representing unviewed on-demand content. Unviewed on-demand content comprises on-demand content which has not been viewed by the particular user before, either in its entirety or only a portion thereof. Furthermore, the previously viewed identifier may comprise simply failing to present the user interface item, wherein only user interface items representing unviewed on-demand content are presented to the user. Method 200 terminates at step 210.

In an embodiment of the invention, a home may include a plurality of set-top devices, for example set-top device 104 and set-top device 104′ (not shown). Set-top device 104 and set-top device 104′ are communicatively coupled, either by one or more of a direct connection between the two (wireline or wireless) or through headend 118. In accordance with this embodiment, a purchase made, for example, on set-top device 104 will cause the on-demand event records of both set-top device 104 and set-top device 104′ to be incremented, such that the on-demand user interfaces associated with set-top devices 104 and 104′ each present a previously viewed identifier to the user with reference to the particular on-demand content purchased solely through set-top device 104.

FIG. 3 is a simplified block diagram illustrating an exemplary on-demand event data structure in accordance with the present invention. On-demand event data structure 300 comprises various on-demand event records, with each record divided into two components, descriptive information column 302 and flag indicator column 304. Descriptive information column 302 comprises a descriptive information field for each on-demand event record. Each descriptive information field comprises descriptive information sufficient to identify the particular on-demand content to which the particular on-demand event record refers. For example, this descriptive information may include, but is not limited to, the title, genre, or summary of the on-demand content. Furthermore, this descriptive information may be provided by the communications network 116, or may be programmed into the set-top device by the user 110.

The flag indicator column of each on-demand event record 304 comprises a flag indicator field which may be flagged to indicate that the particular on-demand content has been previously viewed. This field may be flagged after the user selects particular on-demand content, after a user views the on-demand content for a particular amount of time, or in response to a user command indicating that the content has been previously viewed. In addition to flagging the flag indicator field, the flag indicator field may comprise a numerical value indicating the number of times the particular on-demand content has been previously viewed. The flag indicator field may also possibly comprise user profile information, in a system involving one or more user profiles for users of set-top device 104, which user profile previously viewed the particular on-demand content associated with each flag indicator field.

A “computer-readable carrier” for purposes of embodiments of the present invention may be any medium or transmission that can contain, store, communicate, propagate, or transport the program for use by or in connection with the instruction execution system, apparatus, system or device. The computer readable carrier can be, by way of example only but not by limitation, an electronic, magnetic, optical, electromagnetic, infrared, or semiconductor system, apparatus, system, device, propagation medium, or computer memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in the following claims and/or to the particular embodiment disclosed as the best mode contemplated for carrying out this invention, but that the invention will include any and all embodiments and equivalents falling within the scope of the appended claims.

What is claimed is:

1. A method for presenting on-demand event records via one or more user interface items presented in an on-demand user interface in a communications network, said method comprising the steps of:
determining that particular on-demand content has been previously viewed;
flagging an on-demand event record corresponding to the particular on-demand content as previously viewed; and,
presenting a user interface item representing the on-demand event record with a previously viewed identifier.

2. The method of claim 1, wherein determining that the particular on-demand content has been previously viewed comprises determining the on-demand content has been previously viewed past a particular threshold point.

3. The method of claim 1, wherein flagging the on-demand event record corresponding to the particular on-demand content as previously viewed comprises incrementing a flag indicator field in an on-demand event record corresponding to the particular on-demand content in an on-demand event data structure.

4. The method of claim 1, wherein presenting a user interface item representing the particular on-demand content with a previously viewed identifier comprises presenting the user interface item representing the particular on-demand content in a different color.

5. The method of claim 1, wherein presenting a user interface item representing the particular on-demand content with a previously viewed identifier comprises presenting the user interface item representing the previously viewed content in a different location from one or more user interface items representing unviewed content.

6. The method of claim 1, wherein presenting a user interface item representing the particular on-demand content with a previously viewed identifier comprises presenting only one or more user interface items representing unviewed on-demand content.

7. An apparatus for presenting on-demand event records via an on-demand user interface comprising one or more user interface items presented to a display device coupled to a set-top device, said apparatus comprising:
an on-demand memory for storing on-demand content and an on-demand event data structure, wherein said on-demand event data structure comprises one or more on-demand event records, with each on-demand event record comprising a flag indicator field; and,
a connection to a communications network;
wherein said apparatus determines that particular on-demand content has been previously viewed, and flags the particular on-demand content as previously viewed by incrementing a flag indicator field in an on-demand event record corresponding to the particular on-demand content.

8. The apparatus of claim 7, wherein said apparatus further presents the particular on-demand content with a previously viewed identifier.

9. The apparatus of claim 7, wherein said on-demand events records further comprise a descriptive information field.

10. The apparatus of claim 7, wherein said connection to a communications network comprises a connection to a DOCSIS network.

11. The apparatus of claim 7, wherein said connection to a communications network comprises a connection to a hybrid fiber coaxial network.

12. An apparatus for presenting on-demand event records via an on-demand user interface comprising one or more user interface items presented to a display device coupled to the apparatus, said apparatus comprising:
a set-top memory for storing an on-demand event data structure, wherein said on-demand event data structure comprises one or more on-demand event records, with each on-demand event record comprising a flag indicator field;
a connection to a communications network; and
a connection to a display device;
wherein said apparatus determines that particular on-demand content has been previously viewed, and flags the particular on-demand content as previously viewed by incrementing a flag indicator field in an on-demand event record corresponding to the particular on-demand content.

13. The apparatus of claim 12, further comprising a second set-top memory for storing a second on-demand event data structure, wherein said second on-demand event data structure comprises one or more second on-demand event records, with each second on-demand event record comprising a flag indicator field, wherein the apparatus determines that particular on-demand content has been previously viewed, and flags the particular on-demand content as previously viewed by incrementing a flag indicator field in the second on-demand event record corresponding to the particular on-demand content.

14. The apparatus of claim 12, wherein said apparatus further presents the particular on-demand content with a previously viewed identifier.

15. The apparatus of claim 12, wherein said on-demand events records further comprise a descriptive information field.

16. The apparatus of claim 12, wherein said connection to a communications network comprises a connection to a DOCSIS network.

17. The apparatus of claim 12, wherein said connection to a communications network comprises a connection to a hybrid fiber coaxial network.

18. A system for presenting on-demand event records via an on-demand user interface comprising one or more user interface items, said apparatus comprising:
an on-demand server, said on-demand server comprising a connection to a communications network;
a communications network;
a set-top device, wherein said set-top device comprises a connection to the communications network and a display device;
a display device, said display device being communicatively coupled to said set-top device; and,
an on-demand event data structure comprising one or more on-demand event records, wherein each on-demand event record corresponds to particular on-demand content, and each on-demand event record comprises a flag indicator field;
wherein said system determines that particular on-demand content has been previously viewed; flags the particular on-demand content as previously viewed by incrementing the flag indicator field of the on-demand event record corresponding to the particular on-demand content; and, presents a user interface item representing the particular on-demand content with a previously viewed identifier.

19. The system of claim 18, further comprising:
a second set-top device, wherein said second set-top device comprises a connection to the communications network and a second display device;
a second on-demand event data structure comprising one or more second on-demand event records, wherein each second on-demand event record corresponds to particular on-demand content, and each second on-demand event record comprises a flag indicator field;
wherein said system determines that particular on-demand content has been previously viewed; flags the particular on-demand content as previously viewed by incrementing the flag indicator field of the on-demand event record corresponding to the particular on-demand content; and, presents a user interface item representing the particular on-demand content with a previously viewed identifier.

20. The system of claim 18, wherein said on-demand event database is located within said on-demand server.

21. The system of claim 18, wherein said on-demand event database is located within said set-top device.

22. The system of claim 18, wherein said one or more on-demand event records in said on-demand event data structure further comprises a descriptive information field.

23. The system of claim 18, wherein said communications network comprises a DOCSIS network

24. The system of claim 18, wherein said communications network comprises a hybrid fiber coaxial network.

25. The system of claim 18, wherein said display device comprises a television device.

26. A computer-readable carrier including computer program instructions that instruct a computer to perform the steps of:
determining that particular on-demand content has been previously viewed;
flagging the on-demand event record corresponding to the particular on-demand content as previously viewed; and,
presenting a user interface item representing the on-demand event record with a previously viewed identifier.

27. The computer-readable carrier of claim 26, wherein determining that the particular on-demand content has been previously viewed comprises determining the on-demand content has been previously viewed past a particular threshold point.

28. The computer-readable carrier of claim 26, wherein flagging the on-demand event record corresponding to the particular on-demand content as previously viewed comprises incrementing a flag indicator field in a on-demand event record corresponding to the particular on-demand content in an on-demand event data structure.

29. The computer-readable carrier of claim 26, wherein presenting a user interface item representing the particular on-demand content with a previously viewed identifier comprises presenting the user interface item representing the particular on-demand content in a different color.

30. The computer-readable carrier of claim 26, wherein presenting a user interface item representing the particular on-demand content with a previously viewed identifier comprises presenting the user interface item representing the previously viewed content in a different location from one or more user interface items representing unviewed content.

31. The computer-readable carrier of claim 26, wherein presenting a user interface item representing the particular on-demand content with a previously viewed identifier comprises presenting only one or more user interface items representing unviewed on-demand content.
